(19) United States
(12) Patent Application Publication
(10) Pub. No.: US 2018/0340134 A1
(43) Pub. Date: Nov. 29, 2018

(54) SCENTED CABLE

(71) Applicant: Josh Kovacevic, West Jordan, UT (US)

(72) Inventor: Josh Kovacevic, West Jordan, UT (US)

(21) Appl. No.: 15/990,584

(22) Filed: May 25, 2018

Related U.S. Application Data
(60) Provisional application No. 62/511,294, filed on May 25, 2017.

(51) Int. Cl. C11C 5/00

(52) U.S. Cl. CPC C11C 5/008

(57) ABSTRACT

A cable is disclosed that provides a scent by the outer layer having a fragrance impregnated material or that includes a housing that holds a scented cartridge.

### BACKGROUND

Scents may be provided to the human olfactory senses by a variety of means, such as candles, air fresheners, sprays, essential oils, etc. With devices that provide scents having gained increasing popularity in the market over the years, novel ways of providing scents are sought.

### SUMMARY

A cable is disclosed that provides a scent by the outer layer having a fragrance electrical insulation or that includes an integrated cartridge electrical connector.

### DESCRIPTION OF THE DRAWINGS

FIG. 1 is top view of a cable that includes a housing with a scent cartridge.

FIG. 2 is a top view of a cable that includes a removable housing with a scent cartridge.

FIG. 3 is a top view of a housing for a scent cartridge.

FIG. 4 is a top view of a joinder for a scent cartridge housing.

FIG. 5a is a perspective view of a housing for a circuit board.

FIG. 5b is a perspective view of a housing for a scent cartridge.

FIG. 6 is a perspective view of a housing and a cable.

FIG. 7a is a perspective view of a joinder.

FIG. 7b is a perspective view of a joinder.

FIG. 7c is a perspective view of a joinder.

FIG. 8 is a perspective view of a joinder.

FIG. 9 is a perspective view of a joinder.

FIG. 10 is a perspective view of a joinder.

FIG. 11 is a perspective view of a joinder.

FIG. 12 is a perspective view of a joinder.

FIG. 13a is a side view of a cartridge and joinder.

FIG. 13b is a side view of a cartridge and joinder.

FIG. 13c is a top view of a scent-impregnated cable.

### DETAILED DESCRIPTION

The following discloses a cable that provides a scent by the outer layer having a fragrance impregnated material or that includes a housing that holds a scented cartridge. The cable disclosed provides a scent by the outer layer having a fragrance electrical insulation or that includes an integrated cartridge electrical connector.

An exemplary cable provides scents by having an outer tubular layer that has insulative properties as well as a fragrance impregnated material. The cable may include a housing that includes a sheath around the cable. The sheath may be a one piece unit that wraps circumferentially around the cable. Alternatively, the sheath may have a slit opening that runs longitudinally along one side. Sides of the slit opening are held apart to slip the cable into the sheath. In use, the sides of the sheath encircle the cable for a friction fit. Another exemplary cable includes a housing that holds a scent cartridge. The housing may be permanently affixed to the cable or may be removably affixed. The housing may be part of a connector of the cable. The housing may further be able to be affixed to various different types of cables having different diameter cross-sections, different outer layers, different weavings or materials, and different conductive or connective elements.

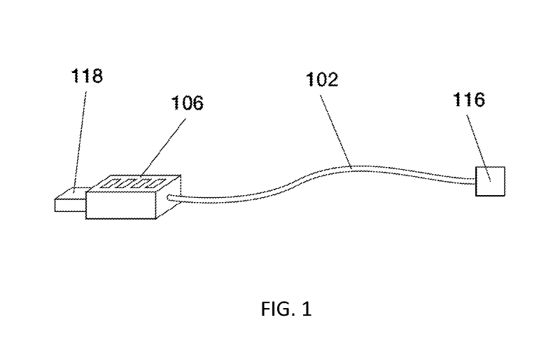

Turning to FIG. 1, an exemplary cable 102 is shown. The cable includes at least one conductive or connective element that extends along a length of the cable. A first electrical connector 116 is at a first end of the cable 102. A second electrical connector 118 is at a second end of the cable. The electrical connector may be a plug, end fitting, coaxial plug, USB adaptor, HDMI adaptor, converter (e.g. video or audio converter), etc. Tips may include an Apple MFI certified 8-pin, micro USO, Type c, and any and all other charging tips.

The cable 102 may be of a variety of different types. For example, the cable 102 may be a cord, telephone wire, laptop charging cable, electrical cable, extension cord, USB cable, electronic device cable, computer cords, coaxial cable, unshielded twisting pair, fiber optic cable, ethernet cable, or coaxial cable. The cable may be one of many types of cables commonly known in the art.

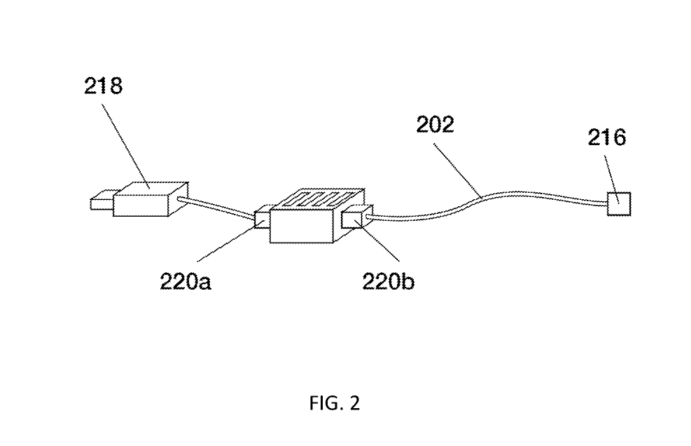

Scent release may involve the use of a housing 106 that is permanently affixed to the cable. The housing 106 or sheath may be shaped like a box or other shape, such as an ovoid, cylindrical, cube, or any other shape that may be used to hold a scent. The housing may include a face shape, animal shape, or flower shape. The housing 106 may have replaceable components that allow the scent to be replaced or the housing to be refilled with scent-releasing material. The housing may have replaceable components that allow the scent to be replaced or the housing to be refilled with scent. Turning to FIG. 2, a removable housing 206 is shown on a cable 202. The housing 206 or sheath includes attachment structure 220a and 220b that permits it to be removably affixed to the cable at a location along a length of the cable 202. In addition, or in the alternative, the housing may include attachment structure that permits the housing to be affixed at endpoints of the cable. Opposing holes may go therethrough to accommodate the cable. Movement of the housing along the length of the cable may include a ratchet, ratchet-like or other configuration that allows the housing incremental movement along the length of the cable. The attachment structure may further permit the housing to rotate axially around a longitudinal axis of the cable. Examples of attachment structure are discussed below.

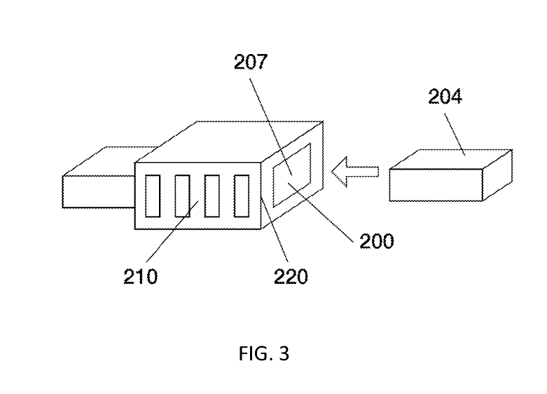

Turning to FIG. 3, an exemplary housing 206 is shown. The housing 206 includes a space 207 that is configured to hold a scent, whether it be in one or more of a solid, liquid, oil, wax, or gas form. An exemplary housing is configured to hold one or more scent cartridges. The scent cartridges 204 may include one or more of a liquid fragrance, fragrance-impregnated solid, essential oil, or wax-based material. The housing may hold or the cartridge may include one or more removable strips such that the removal of a strip uncovers a scent releasing agent. The housing 206 or cartridge may include a spray that can be manually operated to release a scented mist.

Shown in FIG. 3 is a removable housing 212, with a space 207 in the housing for containing a scent cartridge 204, with an opening 200 for inserting the scent cartridge into the space 207 (see arrow). Also, it includes attachment structure 220 that is configured for a joinder or attachment to the cable, to allow the housing to be removably attached to the cable.

The scent cartridge 204 is configured to fit into the housing, and is constructed to suitably retain a scent as with scent cartridges and scent retainers known in the art for room fresheners and the like. The scent cartridge is configured to fit into the housing, and is constructed to suitably contain a scent as with scent cartridges 204 and scent retainers known in the art for room fresheners and the like. Like the housing, the cartridge 204 can be of any practical shape and size. The cartridge may be of a similar shape as the housing or other shape as desired.

The scent cartridge 204 may consist, for example, essentially of a porous solid scent strip of a scent impregnated material 224. The scent cartridge may also comprise additional structure for retaining a scent material, and include a solid, and/or a liquid. The solid may be, for example, an impregnated solid, or a wax-based material. The liquid may be an oil or water-based fragrance, essential oil, or the like. Moreover, the material may include one or more of liquid, gel, wax, wood, natural or synthetic oil, fragrance, solid, or other form. The material may further come in the form of a single piece, multiple pieces or pellets.

The housing includes an opening 200 for inserting and removing cartridges. The housing may include a spring-loaded component, clip, locking structure, or other structure for securing the cartridge within the housing.

The housing may further include one or more vents or slit openings 210 that allow scent to be released from within the housing. The vents may open and close to control the scent release. Furthermore, the opening of the vents may be positioned for partial opening by degrees to allow release of scent by desired amounts.

The material of the housing may include plastic, metal, glass, wood, natural materials, and any combination thereof.

Attachment structure for the housing and/or cartridge may be along one side of the housing. Alternatively, attachment structure may be located at both ends of the housing. Exemplary means of attachment include one or more of a clip, fastener, tie, Velcro, solenoid, screw, catch, clamp, retaining ring, and snap. Half clips may go over the cable to secure the housing or sheath.

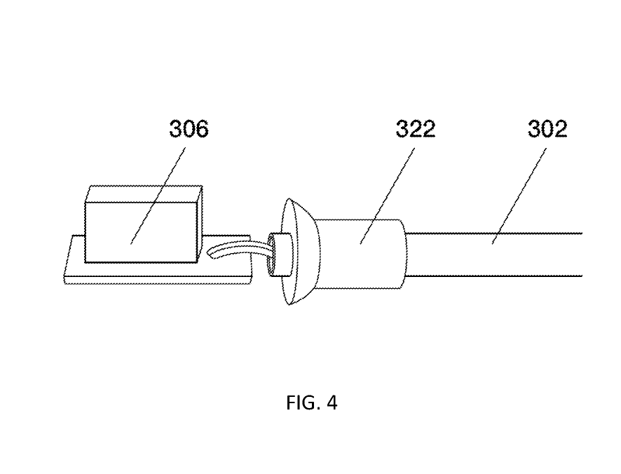

Referring to FIG. 4, shown is a system for joinder or attachment of a scent housing 306 to a cable 302. The attachment structure comprises a casing 322 at the end of the cable that slides over the housing 306 and holds it hi place.

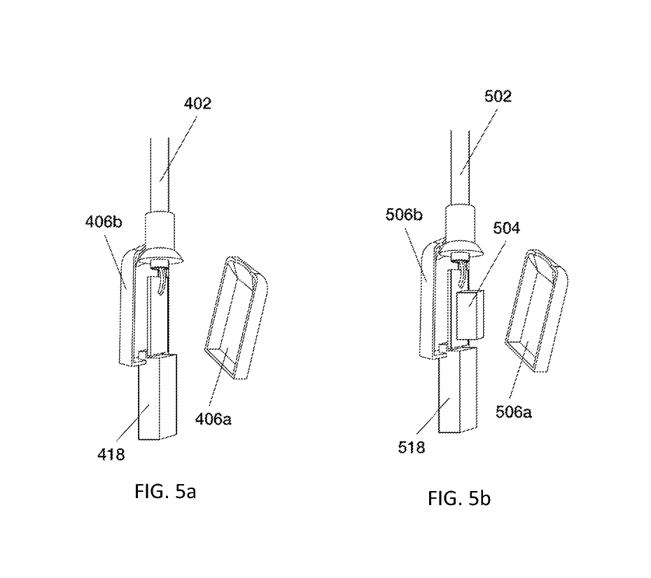

Referring to FIG. 5a, the housing comprises lower first half 406a and second half 406b which together functions as a housing for the electrical connector of the cable 418. In FIG. 5b, is shown housing half 506a, 506b, and electrical connector 518 with scent cartridge 504 that is configured to fit within an interior defined by half 506a and 506b. Embodiments include electrical components or no electrical components between the two halves 506a and 506b. Although shown at the end of the cable next to end connector 518, the housing half 506a and 506b may be located anywhere along the length of the cable.

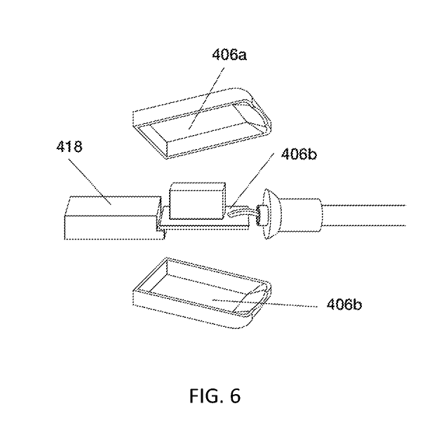

Referring to FIG. 6, shown is a housing as in FIG. 5a with scent cartridge attached to the cable and electrical connector.

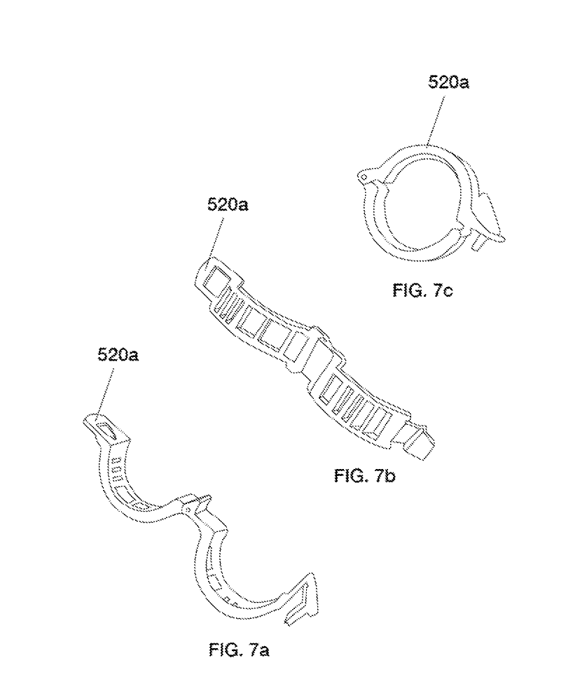

Referring to FIGS. 7a, 7b, and 7c, a joinder or attachment structure is shown comprising a flexible or rubber clip 520a that can be closed and secured (FIG. 7c) around a cable by stretching and locking it to itself. This structure allows the joinder and the attached housing (not shown) to be secured at any point along the length of the cable.

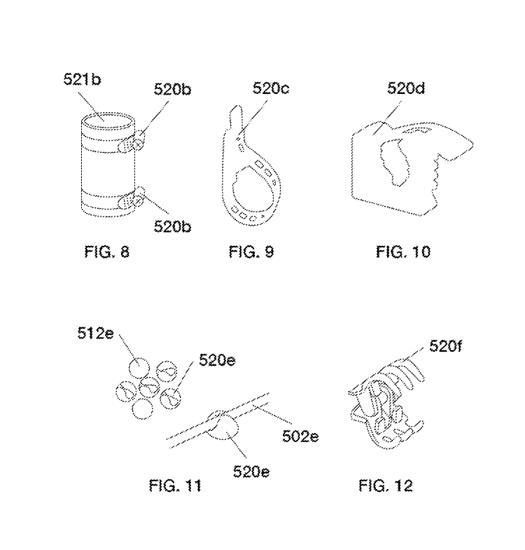

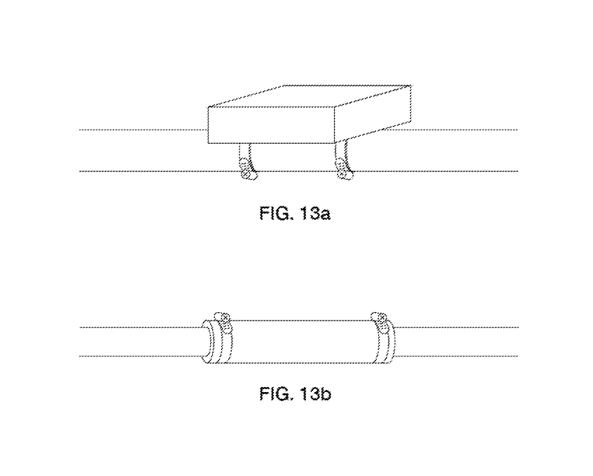

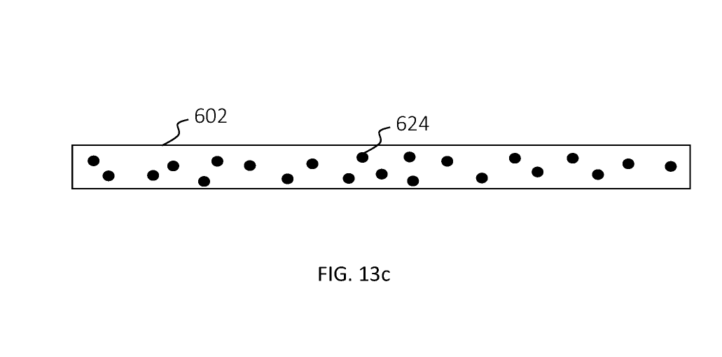

Referring to FIG. 8, a joinder or attachment structure is shown comprising clamps 520a and flexible tube or hose 521b that can contain or be a component of the housing. In one embodiment, the clamps 520a attach through loops, holes, or other corresponding attachment structure located and accessed on an exterior of a cable (see FIG. 13a). The clamps 520a therefore hug the cable and the loop or other structure and secure them together. The attachment structure can be attached at ends of the cartridge housing or at another location along a length of the housing (See FIG. 13b). Also, only one clamp can be used instead of two.

Referring to FIG. 9, a joinder or attachment structure is shown comprising a tie 520c. This structure allows the joinder and the attached housing (not shown) to be secured at any point along the length of the cable.

Referring to FIG. 10, a joinder or attachment structure is shown comprising a snap or clip 520d, that can be placed around the cable and copped and adjusted to accommodate different widths of cables.

Referring to FIG. 11, a removable housing 512e with joinder or attachment structure in the form of a groove 520e in the housing that snaps over the cable 502e and retains housing.

Referring to FIG. 12, a joinder or attachment structure is shown comprising clip 520f that clamps around a cable with handles when pressed together open the clip and allow insertion of the cable.

Referring to FIG. 13c, the cable 602 may be covered by a material that retains scent 602 in the cable. The covering material may be, for example, a sheath around the cable or be the cable insulation. Alternatively, the scent in the cable itself may be provided by a fragrance impregnated material. Materials of the covering or the cable itself may include one or more of wax, paper, plastics, or wood which release fragrance by off gassing. Other commonly known means of releasing scent may also be used. An exemplary housing may be configured to connect to an electrical current that runs through the cable and which is used to heat the housing and the scent components therein. The scent may be released by the heat supplied to the housing and the scent components. Instead of heat, the current may be used to drive a fan. The fan may be used to volatize a substance or material described herein.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention

What is claimed is:

1. A scented cable comprising:
a cable that includes:
at least one conductive element that extends along a length of the cable;
a tubular outer layer that surrounds the at least one conductive element, the outer layer having insulating properties and a fragrance impregnated material.

2. The scented cable of claim 1, further comprising a first electrical connector at a first end of the cable.

3. The scented cable of claim 1, further comprising a second electrical connector at a second end of the cable.

4. The scented cable of claim 1, wherein the cable is a USB cable, co-axial cable, charging cord, extension cord, fiber optic cable, or ethernet cable.

5. A scented cable comprising:
a cable that includes:
at least one conductive strand that extends from the first end to the second of the cable;
a tubular outer layer that surrounds the at least one conductive strand; and
a housing that is permanently affixed to the cable and configured to hold a scent cartridge.

6. The scented cable of claim 4, further comprising a first electrical connector at a first end of the cable.

7. The scented cable of claim 4, further comprising a second electrical connector at a second end of the cable.

8. The scented cable of claim 4, wherein electrical current supplied to the cable heats the housing and the cartridge therein.

9. The scented cable of claim 4, further comprising a pouch that attaches to the cable and that is configured to hold a plurality of replaceable scent cartridges.

10. A scent cartridge housing for a cable comprising:
a housing;
a space within the housing that is configured to hold one or more scent cartridges;
an attachment structure that is configured to removably attach the housing to a cable.

11. The scent cartridge housing of claim 10, wherein the attachment structure is configured to accommodate cables of different sized widths.

12. The scent cartridge housing of claim 10, wherein the attachment structure is configured to attach to an end connector of the cable.

13. The scent cartridge housing of claim 10, wherein the housing includes vents to allow dispersion of fragrance into an environment outside of the housing.

14. The scent cartridge housing of claim 13, wherein the vents include openings that may be modified in size and be fully opened and fully closed and thus provide a control of scent to be released from the one or more scent cartridges.

15. The scent cartridge housing of claim 10, wherein the attachment structure includes one or more of a clip, fastener, tie, Velcro, solenoid, screw, catch, clamp, retaining ring, and snap.

16. The scent cartridge housing of claim 10, wherein the attachment structure includes attachment elements located at opposite ends of the housing.

17. The scent cartridge housing of claim 10, wherein the attachment structure includes variable structure to allow a position of the housing along a length of the cable to be adjusted.

18. The scent cartridge housing of claim 10, wherein the scent cartridge includes one or more of a liquid fragrance, fragrance impregnated solid, essential oil, or wax-based material.

19. The scent cartridge housing of claim 10, wherein the housing includes an opening that is configured to allow a scent cartridge to be placed within the housing and to allow a scent cartridge to be removed from the housing.

20. The scent cartridge housing of claim 10, further comprising an attachment that allows the housing to connect to the cable and be powered to supply heat to the scent cartridge contained therein.
